(19) United States
(12) Patent Application Publication
(10) Pub. No.: US 2026/0158954 A1
(43) Pub. Date: Jun. 11, 2026

(54) Method for Charging a Traction Battery of an Electrically Drivable Vehicle, Vehicle, and Charger

(71) Applicant: Bayerische Motoren Werke Aktiengesellschaft, Muenchen (DE)

(72) Inventor: Boris ZUEV, Muenchen (DE)

(21) Appl. No.: 18/703,906

(22) PCT Filed: Oct. 5, 2022
(86) PCT No.: PCT/EP2022/077705

§ 371 Date: Apr. 23, 2024

(30) Foreign Application Priority Data
Nov. 5, 2021 (DE) 10 2021 128 805.3

(51) Int. Cl. B60L 53/62; B60L 1/00; B60L 53/10; B60L 58/12

(52) U.S. Cl. CPC B60L 53/62; B60L 1/00; B60L 53/11; B60L 58/12; B60L 2240/545; B60L 2250/00

(57) ABSTRACT

A method for charging a vehicle traction battery includes receiving a signal representing a request to charge the battery using a first charging mode, wherein power losses of a charging power supplied from outside the vehicle are lower in the first charging mode than in a second charging mode, determining whether predefined boundary conditions for using the first charging mode are fulfilled, and charging the battery in the first charging mode if the predefined boundary conditions are fulfilled, and otherwise charging the traction battery in the second charging mode, wherein the charging power supplied in the first charging mode and in the second charging mode is in each case supplied via a first electric line. A vehicle and corresponding charger are also disclosed.

### BACKGROUND AND SUMMARY

The present invention relates to a method for charging a traction battery of an electrically drivable vehicle, to a vehicle of this type, and to a corresponding charging device for this vehicle.

Electrically drivable vehicles are known from the prior art, which store and deliver electrical energy for an electric drive system of these vehicles by traction batteries. These traction batteries can be charged, for example, in an “AC charging mode” and/or in a DC (rapid) charging mode.

The AC charging mode, in which an alternating current for charging the traction battery is supplied to the vehicle by an external charging device, requires a corresponding AC/DC converter in the vehicle, in order to generate an appropriate direct current for charging the traction battery.

The DC charging mode, in which a direct current for charging the traction battery is supplied to the vehicle by an external charging device, is generally configured such that a large quantity of charge is introduced into the traction battery within the shortest possible time, in order to permit a rapid resumption of operation of the vehicle.

It is further known from the prior art that, in addition to a voltage level which is employed by the traction battery, and which is customarily in the high-voltage range, at least one further voltage level is employed for the supply of various loads in the vehicle. In current vehicles, for example, voltages of 12 V and/or 48 V are employed as this further voltage level. In many cases, further voltage levels are derived from the voltage level of the traction battery by voltage converters.

One object of the present invention is the provision of a particularly energy-efficient charging mode for a traction battery of an electrically drivable vehicle.

The above-mentioned object is fulfilled by the features as disclosed herein. Preferred further developments of the invention are also the subject matter of the present disclosure.

According to a first aspect of the present invention, a method is proposed for charging a traction battery of an electrically drivable vehicle. In particular, the traction battery can be a high-voltage battery, which preferably delivers voltages up to 400 V or voltages up to 800 V, or voltages which deviate herefrom. The vehicle can be, for example, a road vehicle such as a utility vehicle, a heavy goods vehicle, a motorcycle, a van, etc. In a first step of the method according to the invention, a signal is received which represents a request to charge the traction battery of the vehicle using a first charging mode, wherein a power loss of the charging power which supplied to the vehicle from outside the vehicle in the first charging mode is lower than in a second charging mode which is alternatively provided for charging the traction battery. The first charging mode is to be understood as a particularly energy-efficient charging mode according to the invention, whereas the second charging mode is to be understood as a conventional charging mode (e.g. an AC charging mode or a rapid DC charging mode) which assumes a correspondingly lower energy efficiency. The first charging mode according to the invention is generally intended to ensure that the greatest possible proportion of electrical energy delivered to the vehicle is employed for charging the traction battery whereas, in the first charging mode, the smallest possible proportion of electrical energy supplied is converted into waste heat and/or is consumed by loads of the vehicle which are active during the first charging mode. Advantageously, a power loss associated with the charging of the vehicle in the first charging mode is lower than a power loss associated with the charging of the vehicle in the second charging mode, by a predefined factor. This factor corresponds, for example, to a value greater than 2, preferably to a value greater than 5, and particularly preferably to a value greater than 10, although this factor is not restricted to the above-mentioned values. The signal which represents the request to charge the vehicle in the first charging mode is generated, for example, by the vehicle itself and/or by an apparatus which is arranged separately from the vehicle and/or by a user of the vehicle. Specific origins of the signal are described in greater detail hereinafter in conjunction with the description of advantageous configurations of the invention. The signal is preferably received by an evaluation unit of the vehicle, which is designed to execute the steps of the method according to the invention, for example on the basis of a computer program. The evaluation unit can be a constituent of an existing component of the vehicle (e.g. of a battery management system of the traction battery and/or of a charging control device of the vehicle) or can be a standalone component of the vehicle. In a second step of the method according to the invention, it is determined whether predefined marginal conditions for the application of the first charging mode are fulfilled. Appropriate marginal conditions include, for example, a foreseeable and available forthcoming immobilization time of the vehicle, by way of assurance that, if necessary, compliance with a longer charging time in the first charging mode will be possible. In addition to this marginal condition, numerous other marginal conditions are also conceivable, which are also described in greater detail in conjunction with the description of advantageous configurations of the present invention. In a third step of the method according to the invention, the traction battery is charged in the first charging mode, provided that the predefined marginal conditions are fulfilled, and the traction battery is otherwise charged in the second charging mode, wherein the charging power supplied in the first charging mode and in the second charging mode, in each case, is delivered via a first electric line. Advantageously, the first electric line is a constituent of a charging cable, which is appropriate for connecting the vehicle to an external charging device (e.g. a charging column, a wall box, etc.). In general, it should also be observed that a switchover from the first charging mode to the second charging mode, or from the second charging mode to the first charging mode, during an individual charging process can also generate the benefit of energy-efficient charging according to the invention, particularly if the duration of employment of the first charging mode, as a proportion of the overall charging process, is correspondingly high. A switchover of this type between charging modes, for example, can be appropriate and/or necessary in the event of a change in the above-mentioned marginal conditions during a charging process which is currently in the course of execution. A change of this type can result, for example, from an unforeseen and premature employment of the vehicle, which shortens the immobilization time of the vehicle required for the first charging mode to the extent that the charging process cannot be completed in the first charging mode.

Particularly advantageously, a lower power loss (i.e. a higher efficiency) is achieved in the first charging mode, wherein a charging current for charging the traction battery is adjusted such that compliance with a predefined operating temperature range of the traction battery is achievable on the basis of an exclusively passive cooling of the traction battery. In other words, the proportion of electrical energy which is available for charging the traction battery is increased, in that any active cooling of the traction battery, which would require additional electrical energy, is not necessary. Preferably, an existing temperature sensor system is employed for this purpose in order to permit the setting, in each case, of an appropriate charging current on the basis of temperature measurements executed by this sensor system. Advantageously, in this connection, it is ensured that there is no overshoot, or only a short-term overshoot of a predefined maximum operating temperature range of the traction battery, in order to prevent any impairment of and/or damage to the traction battery associated with the application of the first charging mode. Particularly advantageously, it is thus ensured that, moreover, there is no overshoot, or only a short-term overshoot of a predefined safety margin to the limits of the maximum permissible operating temperature range of the traction battery. Alternatively or additionally, a lower power loss in the first charging mode is achieved wherein a temperature of the traction battery is set such that an impedance of the traction battery is reduced (preferably minimized) and/or such that the traction battery is only charged up to the achievement of a predefined state-of-charge, which is lower than a maximum potential state-of-charge of the traction battery (e.g. up to 80% or 90%), as the efficiency of charging declines with effect from a specific state-of-charge. The optimum operating temperature for the reduction of battery impedance (and thus for the reduction of an impedance-related power loss of the traction battery) is sourced, for example, from a predefined characteristic curve and/or from a characteristic diagram and/or from a table which represents a temperature/impedance relationship of the traction battery. Optionally, it may be appropriate for a temperature setting to be executed such that, rather than the achievement of the minimum impedance of the traction battery, the closest possible approximation to the optimum impedance of the traction battery in consideration of further influencing variables is achieved. An influencing variable of this type can be, for example, an available charging time. As a further alternative, or additionally, a lower power loss in the first charging mode is achieved wherein a first predefined group of loads in the vehicle, which are required for an automatic control and/or an automatic monitoring of the charging of the traction battery, are activated or maintained active, whereas a second group of loads, which differs from the first group, are deactivated or maintained inactive during the first charging mode. Advantageously, all loads of the vehicle which are not assigned to the first group of loads are deactivated, but not by way of limitation. Optionally, any requisite vehicle functions which are not associated with the charging process itself, but which are necessary for the maintenance of the unimpaired operation of the vehicle and/or for the resumption of operation of the vehicle (e.g. an access control function) can be permanently and/or temporarily transferred to a component which is required for charging operation and/or can be redundantly configured in an electrical component which is required for charging operation, such that the activation or maintenance in an active state of a correspondingly smaller number of electrical components or control devices of the vehicle is required. Moreover, an above-mentioned transfer of functions in electrical components which are required for a charging operation can also include a transfer and/or redundant configuration of functions of a charging control device of the vehicle (which, for example, exchanges information with an external charging device for the execution of a charging process) in a battery management system of the traction battery and/or in a component which differs therefrom.

In an advantageous configuration of the present invention, the second group of loads is a predefined group of loads. The second group of loads, for example, can be predefined with respect to a respective functionality and/or relevance and/or magnitude of consumption. Alternatively or additionally, the second group of loads is dynamically adjusted in accordance with present and/or future marginal conditions and/or in accordance with a foreseeable future utilization of the vehicle (e.g. a future heat-up of the vehicle interior which will be required shortly before the start of travel) before and/or during charging.

The second group of loads preferably comprises electric power converters (e.g. for the conversion of a charging voltage for the traction battery into a low voltage or extra-low voltage) and/or air-conditioning devices and/or communication control devices and/or entertainment system control devices and/or control devices for the autonomous or partially autonomous driving operation of the vehicle, wherein the above-mentioned categories of loads are not specified by way of limitation.

In a further advantageous configuration of the present invention, a charging power employed during the first charging mode is a DC charging power which is delivered separately from the vehicle and which, with respect to its core electrical variables, remains constant for the charging of the traction battery. In other words, charging power for charging the traction battery is delivered such that no additional power conversion is required (e.g. by a DC/DC converter) within the vehicle for charging the traction battery by the charging power. This prevents any energy losses, during charging in the first charging mode, associated with waste heat which is generated in conjunction with the conversion of electric power.

In a particularly advantageous configuration of the present invention, during the first charging mode, active low-voltage loads which are designed to operate at a predefined low voltage are supplied by a voltage which is delivered separately from the vehicle, which corresponds to the above-mentioned low voltage, and which is supplied via a second electric line which differs from the first electric line. It should be observed that, in this manner, it is also possible for more than one low-voltage level to be supplied wherein, in each case, additional electric lines (e.g. a third line, fourth line, etc.) are provided. Low-voltage loads described herein are particularly to be understood as low-voltage loads rated in a voltage range up to 12 V and/or up to 48 V and/or up to 60 V, wherein these voltage ranges are not indicated by way of limitation. In principle, this category includes loads of the vehicle which operate at a voltage level which differs from the voltage level of the traction battery. External delivery of the requisite low voltage eliminates the necessity for the maintenance in service or activation of corresponding voltage converters in the vehicle during the first charging mode, as a result of which any power loss generated by voltage converters in the first charging mode is no longer generated in the vehicle itself. This provides an advantage, in that there is no necessity for the employment of active cooling in the vehicle for any such conversion, which requires electrical energy and which correspondingly impairs efficiency during the charging of the vehicle. Preferably, the low voltage which can be generated in a charging device which is arranged separately from the vehicle, and which can be supplied to the vehicle via the second electric line, is generated such that any cooling required in conjunction with the generation of a low voltage is executed passively, either entirely or at least in part. The transfer of voltage conversion during the first charging mode from the vehicle to a charging device of this type provides an advantage, inter alia, in that cooling in the external charging device can be executed with a higher degree of flexibility on the grounds that, in general, an external charging device is subject to less stringent requirements with respect to the size and/or shape of such a converter and/or with respect to the passive cooling thereof.

Marginal conditions for the employment of the first charging mode preferably include the above-mentioned forthcoming minimum immobilization time of the vehicle which, in particular, is determined in accordance with a present and/or future temperature of the traction battery. By the consideration of temperature, it can correspondingly be ensured that active cooling of the traction battery, which consumes electrical energy, is not necessary. Depending upon the current temperature of the traction battery, for example, it can be decided whether a charging process according to the first charging mode can be executed immediately after the parking of the vehicle, or whether it is necessary to await a later time point, at which the battery has cooled down to the requisite temperature. Alternatively or additionally, marginal conditions preferably include current and/or future ambient temperatures which, in particular, can be considered in conjunction with the determination of the current and/or future temperature of the traction battery. Alternatively or additionally, a present state-of-charge and a target state-of-charge can be considered as marginal conditions. In this regard, depending upon whether or not a high quantity of charge is introduced into the battery during the charging process, it can be determined, for example, whether a foreseeable forthcoming immobilization time of the vehicle, in consideration of ambient temperatures, is sufficient for the application of the first charging mode. Particularly advantageously, alternatively or additionally, the existence of an influencing option for reducing the ambient temperature of the traction battery is considered as a marginal condition. An influencing option of this type can be determined, for example, by an environment recognition system of the vehicle which, for example, can automatically identify passive ventilation and/or cooling options in the form of openable garage windows and/or openable garage doors and/or surrounding areas of shade, etc. In response to such determination, for example, an instruction can be delivered to a user of the vehicle, by which the user is notified that the traction battery can be charged using the first, i.e. the energy-efficient charging mode, provided that, additionally, an option is identified for the cooling of the traction battery which can be provided by the user during the charging process. This instruction can further include a specific proposal for action by the user (e.g. opening of the garage door, parking of the vehicle in the shade, etc.). An instruction message output of this type can be delivered to the user of the vehicle, for example upon the parking of the vehicle or the switch-off of the vehicle, on a display within the vehicle and/or on a portable user terminal device (e.g. a smartphone, tablet, smart watch, etc.) having a wireless IT connection to the vehicle. Alternatively or additionally, influencing options thus identified which, moreover, can also be identified via a communication of the vehicle with smart home control devices (e.g. an automatic garage door drive system), can be employed for the automatic adaptation of the vehicle and/or of the environment thereof, in order to establish the requisite marginal conditions for charging in the first charging mode. In this manner, for example, the opening of a smart home garage door opening system can be actuated by the vehicle in the event of an excessive rise in the temperature of the traction battery during charging. Alternatively or additionally, it is also conceivable that the vehicle, where the latter is equipped for (partially) autonomous driving and has a charging cable of appropriate length, is maneuvered into a shady and/or better ventilated area.

Advantageously, the signal is generated by a user input and/or is generated automatically on the basis of an operating history of the vehicle and/or on the basis of a current position of the vehicle and/or on the basis of a current time and/or on the basis of calendar data for a user of the vehicle.

The manual request for the first charging mode, for example, can additionally be supported wherein, at an appropriate time point (e.g. upon the parking of the vehicle), an output instruction is delivered for the attention of the user (for example, in accordance with the above-mentioned options for the output of an instruction to a user), which notifies the user to the effect that, on the basis of an automatically determined and foreseeable immobilization time of the vehicle and/or in accordance with further marginal conditions, a charging process in the first charging mode is possible. Automatic generation of the signal, for example, can still be executed if a charging device is electrically coupled to the vehicle which is designed to support the first charging mode (e.g. by a second voltage level delivered via the second electric line).

According to a second aspect, a vehicle is proposed which comprises an evaluation unit which is designed to execute a method according to the invention, in accordance with the preceding description. The evaluation unit can be configured, for example, in the form of an ASIC, a FPGA, a digital signal processor, a microcontroller or similar. The features, combinations of features and advantages proceeding therefrom manifestly correspond to those described above with respect to the first-mentioned aspect of the invention such that, in the interests of the avoidance of repetition, reference may be made to the preceding descriptions.

In an advantageous configuration of the vehicle according to the invention, the vehicle comprises a charging interface having a first electrical connection and a second electrical connection, wherein the vehicle is designed, via the charging interface, for electrical connection to a corresponding charging interface which is arranged separately from the vehicle (e.g. a charging column or wall box), to draw a charging power for charging a traction battery of the vehicle via the first electrical connection, to draw a low voltage via the second electrical connection, and to supply the low voltage to those low-voltage loads of the vehicle which are active during a charging operation of the traction battery.

The first electric line and the second electric line are preferably arranged in one and the same charging cable. The first electric line and the second electric line respectively comprise two electrical conductors (outward and return conductors), which are rated for the respective electrical capacities to be transmitted and which are formed, for example, of copper and/or of aluminum and/or of an electrically conductive material which differs therefrom. The charging interface of the vehicle is preferably configured in the form of a plug connector having a predefined connector face in which respective contacts for the first line and the second line are provided.

According to a third aspect of the present invention, a charging device is proposed (e.g. in the form of a charging column, a wall box, etc.), which comprises a charging interface having a first electrical connection, a second electrical connection and a passive cooling device. The charging device is designed for connection, via the charging interface, to a corresponding charging interface of a vehicle, in particular of an above-mentioned vehicle, to deliver a charging power via the first electrical connection which is appropriate for charging a traction battery of a vehicle which is electrically connectable to the charging interface, and to deliver a low voltage via the second electrical connection which is appropriate for the supply of at least one electrical load of a vehicle which is electrically connectable to the charging device. The low voltage is preferably a low voltage as defined in the context of the preceding description of the method according to the invention. The voltage delivered via the first electrical connection differs from the voltage which is delivered via the second electrical connection. The charging device is further designed to cool components which are involved in the supply of the low voltage, and which require cooling during the active operation of the charging device, by the passive cooling device. The cooling device is configured, for example, in the form of a heat sink having a plurality of cooling ribs and which, in the interests of effective heat evacuation, is preferably arranged partially and/or entirely on an outer side of the charging device. However, this does not exclude an option for the arrangement thereof within a housing of the charging device which, particularly in conjunction with an appropriate number and/or size of ventilation slots configured in a housing wall of the charging device, can also result in an adequate passive cooling of the charging device. The charging interface of the charging device is preferably configured in an analogous manner to the charging interface of the vehicle, in the form of a plug connector having a connector face, which corresponds to the connector face of the charging interface of the vehicle according to the invention.

Further details, features and advantages of the invention proceed from the following description and from the figures.

### BRIEF DESCRIPTION OF THE DRAWINGS

FIG. 1 shows a flow diagram illustrating steps of an exemplary embodiment of the method according to the present disclosure; and

FIG. 2 shows a schematic overview of components of a vehicle according to the present disclosure, connected to a charging device according to the present disclosure.

### DETAILED DESCRIPTION OF THE DRAWINGS

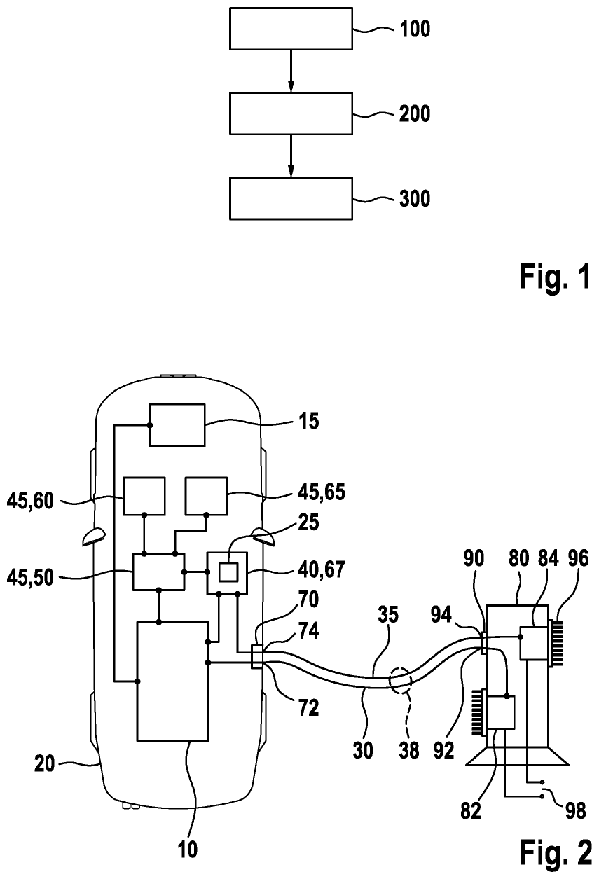

FIG. 1 shows a flow diagram illustrating steps of an exemplary embodiment of a method according to the present disclosure for charging a traction battery 10 of an electrically drivable vehicle 20. In step 100 of the method according to the present disclosure, by an evaluation unit 25 of the vehicle according to the present disclosure which, in the present case, is configured in the form of a microcontroller, a signal is received which represents a request for charging the traction battery 10 of the vehicle 20 by the employment of a first charging mode, wherein a power loss, which is associated with a charging power which is supplied to the vehicle 20 from an external source to the vehicle 20, is lower in the first charging mode than in a second charging mode which is provided as an alternative for charging the traction battery 10. In this case, the signal is triggered in response to an input of a user of the vehicle 20 on a touchscreen of the vehicle 20, as the user intends, in this case, to charge the vehicle 20 overnight by the first charging mode according to the present disclosure. In step 200 of the method according to the present disclosure, it is determined by the evaluation unit 25 whether predefined marginal conditions for the employment of the first charging mode are fulfilled. In this case, marginal conditions comprise a future minimum immobilization time, a current temperature of the traction battery 10, and a foreseeable temperature characteristic of an ambient temperature of the vehicle 20, which is automatically determined on the basis of a weather forecast. On the basis of marginal conditions, it is determined by the evaluation unit 25 whether the future minimum immobilization time, which is automatically determined on the basis of the operating history of the vehicle 20, is sufficient for the achievement of a predefined target state-of-charge of the traction battery 10, without the necessity for the employment of active cooling of the traction battery 10. As the minimum immobilization time is sufficient in this case, the traction battery 10 is charged using the first charging mode, immediately the user of the vehicle 20 connects a charging interface 70 of the vehicle 20 to a charging interface 90 of a charging device 80 which corresponds to the vehicle 20.

FIG. 2 shows a schematic overview of components of a vehicle 20 according to the present disclosure, which is connected to a charging device 80 according to the present disclosure. The vehicle 20 comprises a traction battery 10 which is designed to supply electrical energy to an electric drive motor 15 of the vehicle 20. The vehicle 20 further comprises a charging module 67, which comprises an evaluation unit 25 according to the present disclosure. The charging module 67 is assigned to a first group 40 of loads of the vehicle 20, which are maintained active during a charging of the traction battery 10 by the employment of a first charging mode according to the present disclosure, in order to permit the control and monitoring of the charging process. The vehicle 20 further comprises a second group 45 of loads, which are deactivated by the evaluation unit 25 during a first charging mode. In this case, the second group 45 of loads comprises an electric power converter 50, which is designed to supply an air-conditioning device 60 and an entertainment system control device 65 of the vehicle 20, which are also assigned to the second group 45 of loads, with electric power which is tapped from the traction battery 10 and is converted into an appropriate power for the second group 45 of loads. By the deactivation of the second group 45 of loads, a maximum energy efficiency is achieved during the charging of the traction battery 10, as no unnecessary loads of the vehicle 20 are active. A supply to the charging module 67, and to the evaluation unit 25 according to the present disclosure which is contained therein, is maintained via a charging interface 70 of the vehicle 20. The charging interface 70 comprises a first electrical connection 72 for charging the traction battery 10 and a second electrical connection 74 for supplying the first group 40 of loads during the first charging mode. By a first electric line 30 and by a second electric line 35 of a charging cable 38, the electrical connections 72, 74 of the vehicle 20 are respectively designed to connect to corresponding electrical connections 92, 94 of a charging interface 90 of the charging device 80. The charging device 80 comprises a power converter 82 which is designed to convert a grid voltage of a power grid 98 into an appropriate charging power for the traction battery 10, and to execute the delivery thereof via the first electric line 30. The charging device 80 further comprises a low-voltage converter 84, which is designed to convert the grid voltage into a low voltage at a value of 12 V, and to execute the delivery thereof via the second electric line 35. Advantageously, the low-voltage converter 84 is thermally coupled to a passive cooling device 96, which comprises a plurality of cooling ribs and which is arranged on an outer side of a housing of the charging device 80. In this manner, energy efficiency in the first charging mode is further improved, as it is not necessary for the supply voltage for the charging module 67 to be converted by the electric power converter 50 of the vehicle 20 during the first charging mode, as a result of which any energy loss associated with the active cooling required for this purpose is eliminated.

List of reference numbers:

| | |
|---|---|
| 10 | Traction battery |
| 20 | Vehicle |
| 25 | Evaluation unit |
| 30 | First electric line |
| 35 | Second electric line |
| 40 | First group of loads |
| 45 | Second group of loads |
| 50 | Electric power converter |
| 60 | Air-conditioning device |
| 65 | Entertainment system control device |
| 67 | Charging module |
| 70 | Charging interface of the vehicle |
| 72 | First electrical connection of the charging interface of the |
| | vehicle |
| 74 | Second electrical connection of the charging interface of the |
| | vehicle |
| 80 | Charging device |
| 90 | Charging interface of the charging device |
| 92 | First electrical connection of the charging interface of the |
| | charging device |
| 94 | Second electrical connection of the charging interface of the |
| | charging device |
| 96 | Passive cooling device |
| 100-300 | Steps of the method |

1-12. (canceled)

13. A method for charging a traction battery of an electrically drivable vehicle, the method comprising:
receiving a signal that represents a request for charging the traction battery of the vehicle by employment of a first charging mode, wherein a power loss that is associated with a charging power supplied to the vehicle from an external source to the vehicle is lower in the first charging mode than in a second charging mode that is provided as an alternative for charging the traction battery;
determining whether marginal conditions for application of the first charging mode are fulfilled; and
charging the traction battery in the first charging mode in response to determining that the marginal conditions are fulfilled, and charging the traction battery otherwise in the second charging mode, wherein the charging power supplied in the first charging mode and in the second charging mode, in each case, is delivered via a first electric line.

14. The method according to claim 13,
wherein a lower power loss is achieved in the first charging mode,
wherein a charging current for charging the traction battery is adjusted such that:
compliance with a predefined operating temperature range of the traction battery is achievable on a basis of an exclusively passive cooling of the traction battery;
and/or
a temperature of the traction battery is set such that an impedance of the traction battery is reduced;
and/or
wherein the traction battery is only charged up to an achievement of a predefined state-of-charge, which is lower than a maximum potential state-of-charge of the traction battery;
and/or wherein a first predefined group of loads in the vehicle, which are required for an automatic control and/or an automatic monitoring of the charging of the traction battery, are activated or maintained active, whereas a second group of loads, which differs from the first group, are deactivated or maintained inactive during the first charging mode.

15. The method according to claim 14, wherein the second group of loads:
is a predefined group of loads; and/or
is a group of loads which is dynamically adjusted:
in accordance with present and/or future marginal conditions before and/or during charging; and/or
in accordance with a foreseeable future utilization of the vehicle before and/or during charging.

16. The method according to claim 14, wherein the second group of loads comprises:
an electric power converter;
air-conditioning devices;
communication control devices; and/or
entertainment system control devices and/or control devices for autonomous or partially autonomous driving operation of the vehicle.

17. The method according to claim 13, wherein the second charging mode is a rapid DC charging mode or an AC charging mode.

18. The method according to claim 13, wherein a charging power employed during the first charging mode is a DC charging power which is delivered separately from the vehicle, and which, with respect to its core electrical variables, remains constant for the charging of the traction battery.

19. The method according to claim 13, wherein, during the first charging mode, active low-voltage loads which are designed to operate at a predefined low voltage are supplied by a voltage which is delivered separately from the vehicle, which corresponds to the predefined low voltage, and which is supplied via a second electric line which differs from the first electric line.

20. The method according to claim 13, wherein predefined marginal conditions for employment of the first charging mode comprise:
a forthcoming minimum immobilization time of the vehicle which is determined in accordance with:
a present and/or future temperature of the traction battery;
a present and/or future ambient temperature; and/or
a present state-of-charge and a target state-of-charge of the traction battery;
and/or
an existence of an influencing option for reducing the ambient temperature of the traction battery.

21. The method according to claim 13, wherein the signal is generated:
by a user input, and/or
automatically, on a basis of at least one of the following:
an operating history of the vehicle;
a current position of the vehicle;
a current time; and/or
calendar data for a user of the vehicle.

22. A vehicle comprising:
a traction battery; and
an evaluation unit comprising at least one processing device, the at least one processing device configured to:
receive a signal that represents a request for charging the traction battery by employment of a first charging mode, wherein a power loss that is associated with a charging power supplied to the vehicle from an external source to the vehicle is lower in the first charging mode than in a second charging mode that is provided as an alternative for charging the traction battery;
determine whether marginal conditions for application of the first charging mode are fulfilled; and
cause the traction battery to be charged in the first charging mode in response to determining that the marginal conditions are fulfilled, and cause the traction battery to be charged otherwise in the second charging mode, wherein the charging power supplied in the first charging mode and in the second charging mode, in each case, is delivered via a first electric line.

23. The vehicle according to claim 22, comprising:
a charging interface having a first electrical connection and a second electrical connection,
wherein the vehicle is configured to:
electrically connect, via the charging interface, to a corresponding second charging interface which is arranged separately from the vehicle;
draw a charging power for charging the traction battery via the first electrical connection; and
draw a low voltage via the second electrical connection, and to supply the low voltage to low-voltage loads of the vehicle which are active during a charging operation of the traction battery.

24. The vehicle according to claim 22,
wherein a lower power loss is achieved in the first charging mode,
wherein a charging current for charging the traction battery is adjusted such that:
compliance with a predefined operating temperature range of the traction battery is achievable on a basis of an exclusively passive cooling of the traction battery;
and/or
a temperature of the traction battery is set such that an impedance of the traction battery is reduced;
and/or
wherein the traction battery is only charged up to an achievement of a predefined state-of-charge, which is lower than a maximum potential state-of-charge of the traction battery; and/or
wherein a first predefined group of loads in the vehicle, which are required for an automatic control and/or an automatic monitoring of the charging of the traction battery, are activated or maintained active, whereas a second group of loads, which differs from the first group, are deactivated or maintained inactive during the first charging mode.

25. The vehicle according to claim 24, wherein the second group of loads:
is a predefined group of loads; and/or
is a group of loads which is dynamically adjusted:
in accordance with present and/or future marginal conditions before and/or during charging; and/or
in accordance with a foreseeable future utilization of the vehicle before and/or during charging.

26. The vehicle according to claim 24, wherein the second group of loads comprises:
an electric power converter;
air-conditioning devices;
communication control devices; and/or
entertainment system control devices and/or control devices for autonomous or partially autonomous driving operation of the vehicle.

27. The vehicle according to claim 22, wherein the second charging mode is a rapid DC charging mode or an AC charging mode.

28. The vehicle according to claim 22, wherein a charging power employed during the first charging mode is a DC charging power which is delivered separately from the vehicle, and which, with respect to its core electrical variables, remains constant for the charging of the traction battery.

29. The vehicle according to claim 22, wherein, during the first charging mode, active low-voltage loads which are designed to operate at a predefined low voltage are supplied by a voltage which is delivered separately from the vehicle, which corresponds to the predefined low voltage, and which is supplied via a second electric line which differs from the first electric line.

30. The vehicle according to claim 22, wherein predefined marginal conditions for employment of the first charging mode comprise:
a forthcoming minimum immobilization time of the vehicle which is determined in accordance with:
a present and/or future temperature of the traction battery;
a present and/or future ambient temperature; and/or
a present state-of-charge and a target state-of-charge of the traction battery;
and/or
an existence of an influencing option for reducing the ambient temperature of the traction battery.

31. The vehicle according to claim 22, wherein the signal is generated:
by a user input, and/or
automatically, on a basis of at least one of the following:
an operating history of the vehicle;
a current position of the vehicle;
a current time; and/or
calendar data for a user of the vehicle.

32. A charging device comprising:
a charging interface having a first electrical connection and a second electrical connection; and
a passive cooling device,
wherein the charging device is configured to:
connect, via the charging interface, to a corresponding second charging interface of a vehicle;
deliver a charging power via the first electrical connection that is appropriate for charging a traction battery of the vehicle which is electrically connectable to the charging interface;
deliver a low voltage via the second electrical connection that is appropriate for supplying at least one electrical load of the vehicle; and
cool components of the charging device which are involved in supply of the low voltage and which require cooling during active operation of the charging device by the passive cooling device.
